(19) United States
(12) Patent Application Publication
(10) Pub. No.: US 2006/0181499 A1
(43) Pub. Date: Aug. 17, 2006

(54) Scan method for liquid crystal display

(75) Inventors: Huan-Hsin Li, Toufen Township (TW); Yao-Jen Hsieh, Pingtung City (TW); Chih-Sung Wang, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/152,492

(22) Filed: Jun. 14, 2005

(30) Foreign Application Priority Data
Feb. 17, 2005 (TW) 94104605

(51) Int. Cl. G09G 3/36

(52) U.S. Cl. 345/100

(57) ABSTRACT

A scan method for use in a flat panel display comprising K groups of lines, comprising the following steps. First, K sequences S₁ to S_{K} are provided. A scan order is then determined according to the K sequences S₁ to S_{K}. Thereafter, the K groups of lines are synchronously scanned by the scan order. K is an integer not less than 2. Each group of lines comprises at least M lines.

### BACKGROUND

The invention relates to a scan method for liquid crystal display, and in particular, to a scan method providing specific scan order that optimizes the image.

In flat panel displays, resolution grows higher and higher, as a result, response time becomes a major issue. FIG. 1 shows a conventional pixel driving circuit 100. The pixel driving circuit 100 is divided into an upper part 106 and a lower part 108, each comprising a plurality of lines. A first gate driver 102 and a second gate driver 104 are coupled to the upper part 106 and lower part 108 respectively for control of the lines therein. The scan order as shown by the arrows in the FIG. 1, recursively scans from the top to the bottom of each half part. The first gate driver 102 and second gate driver 104 need only process a half part of the flat panel display, taking half the time than before, therefore the saved time can be used for additional processes.

FIG. 2 is a timing chart of a conventional scan method, showing the driving order of the 1080 lines in the flat panel display. The 1080 lines are divided into an upper part 106 and lower part 108, each comprising 540 lines. The horizontal axis represents display enable signal DE, and each of the signals G1 to G1080 individually drives a corresponding line. When DE=1, the upper part 106 activates signal G1, and the lower part 108 activates signal G541. The lines are sequentially driven until DE=540, and when DE=541, the process returns to signal G1 and G541, thus forming a loop. A total of 1080 lines are scanned every 540 clocks because two lines are scanned per clock.

### SUMMARY

An embodiment of the invention provides a scan method for use in a flat panel display comprising K groups of lines, comprising the following steps. First, K sequences S₁ to S_{K} are provided. A scan order is then determined according to the K sequences S₁ to S_{K}. Thereafter, the K groups of lines are synchronously scanned by the scan order. K is an integer not less than 2. Each group of lines comprises at least M lines.

The step of providing K sequences S₁ to S_{K} comprises the following steps. First, K shift values N₁ to N_{K} are provided, and the shift values are not greater than M. The sequences S₁ to S_{K} are then determined based on the shift values N₁ to N_{K}.

The step of determining the scan order comprises sequentially selecting all the first elements in the sequences S₁ to S_{K}, all the second elements in the sequences S₁ to S_{K}, and so on until the Mₜₕ elements of the sequences S₁ to S_{K}, form the scan order comprising K*M elements.

The step of providing K shift values comprises determining the shift values according to characteristics of the images displayed. The sequences S₁ to S_{K} are:
Sᵢ(x)=(x+Nᵢ) (mod M), i=1 to K, x=1 to M;

Where Sᵢ(x) denotes the xₜₕ element in sequence Sᵢ. The shift value N₁ is zero, and the shift values N₂ to N_{K} are determined based on the ratio of M and K.

Another embodiment of the invention provides a timing controller implementing the described scan method, and a pixel driving circuit comprising the timing controller.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional pixel-driving circuit 100;

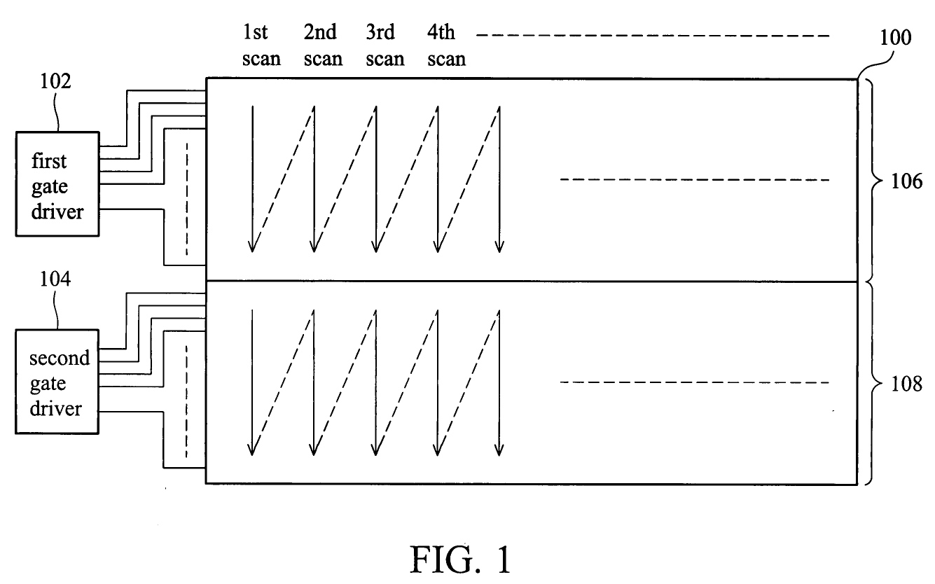

FIG. 2 is a timing chart of conventional scan method;

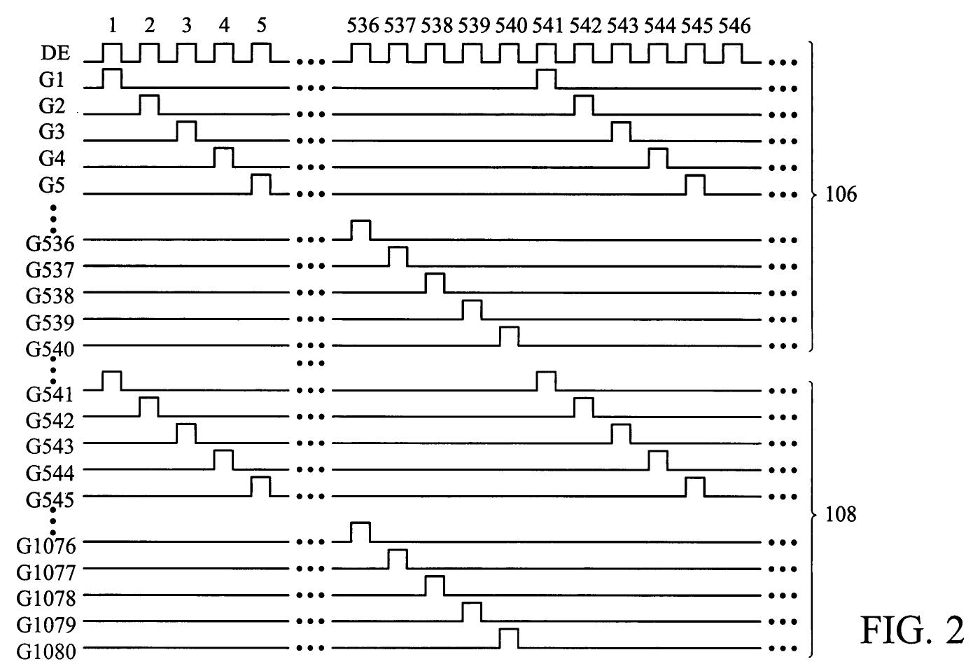

FIG. 3 is a flowchart according to an embodiment of the invention;

FIG. 4a shows an embodiment of the scan sequences;

FIG. 4b is a timing chart according to FIG. 4a;

FIG. 4c and embodiment of the scan sequences; and

FIG. 5 shows an embodiment of a pixel driving circuit 500.

### DETAILED DESCRIPTION OF THE INVENTION

The invention takes advantage of the time saved from the divided scan.

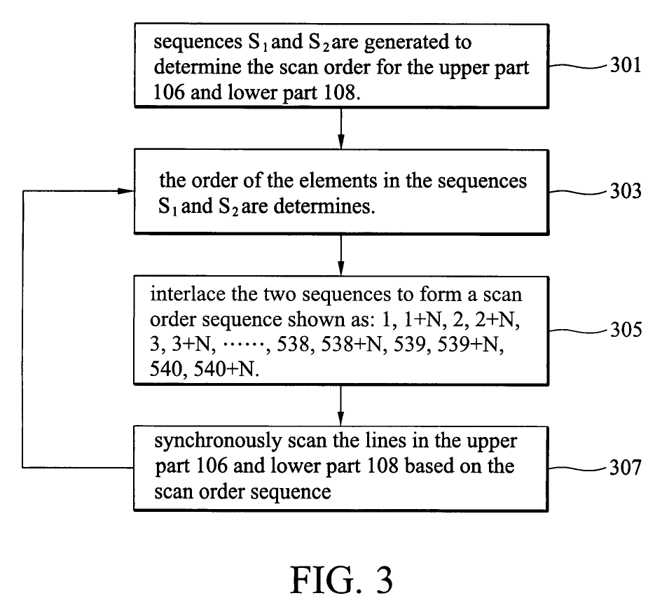

FIG. 3 is a flowchart according to an embodiment of the invention. The 1080 lines in a flat panel display are divided into groups, such as upper part 106 and lower part 108 each comprising 540. lines. In step 301, sequences S₁ and S₂ are performed to determine the scan order for the upper part 106 and lower part 108. The sequences S₁ and S₂ comprise 540 elements. In step 303, the order of the elements in the sequences S₁ and S₂ are determined. For example, The sequence S₁ is: 1, 2, 3, . . . , 538, 539, 540, which is a natural number sequence. The sequence S₂ is: 1+N, 2+N, 3+N . . . , 538+N, 539+N, 540+N, a shifted sequence. The elements in sequence S2 are congruent to 540, and the N is an integer parameter not greater than 540. In step 305, interlacing the two sequences to form a scan order sequence shown as: 1, 1+N, 2, 2+N, 3, 3+N . . . , 538, 538+N, 539, 539+N, 540, 540+N. In step 307, the lines in the upper part 106 and lower part 108 are synchronously scanned based on the scan order sequence, thereby a total of 1080 lines are scanned twice within one time frame, and the N determines the interval of the two scans.

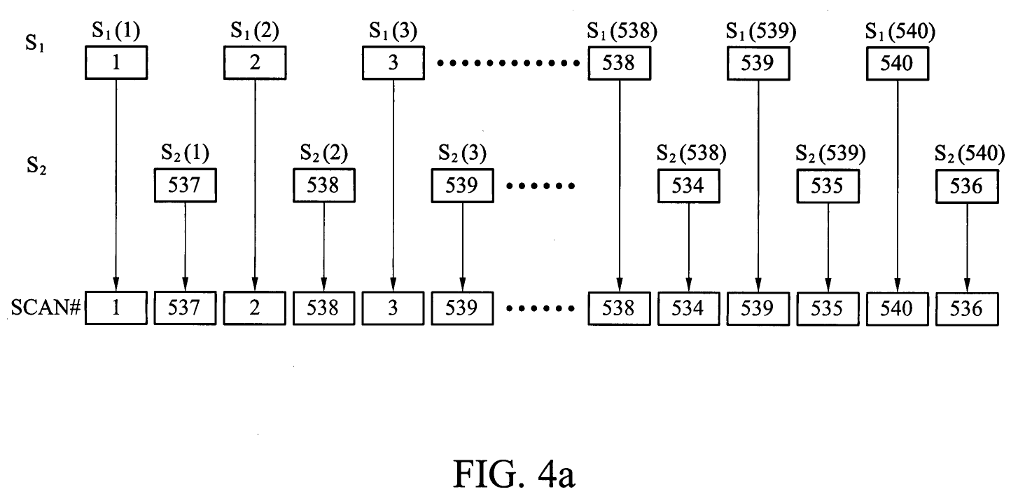

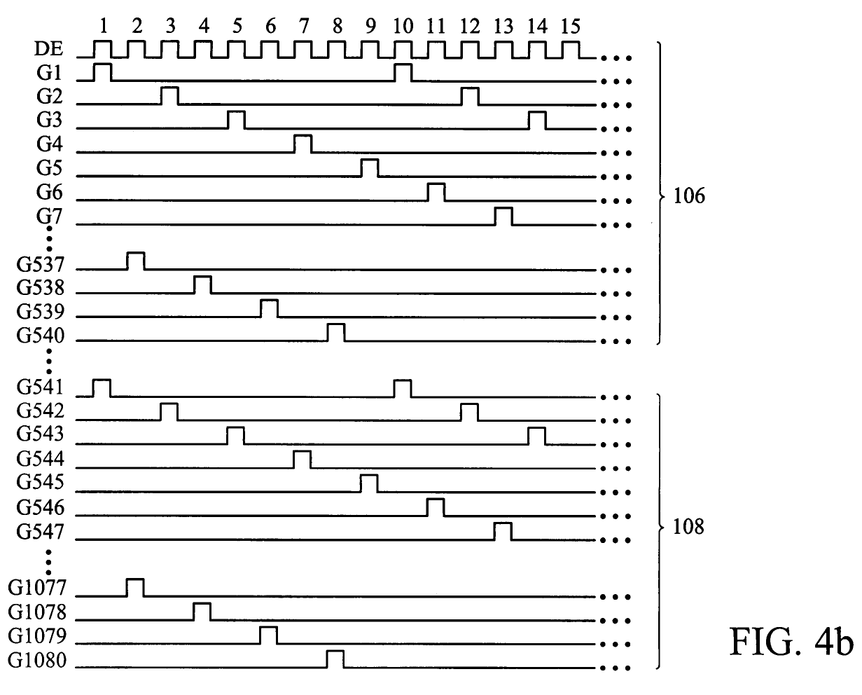

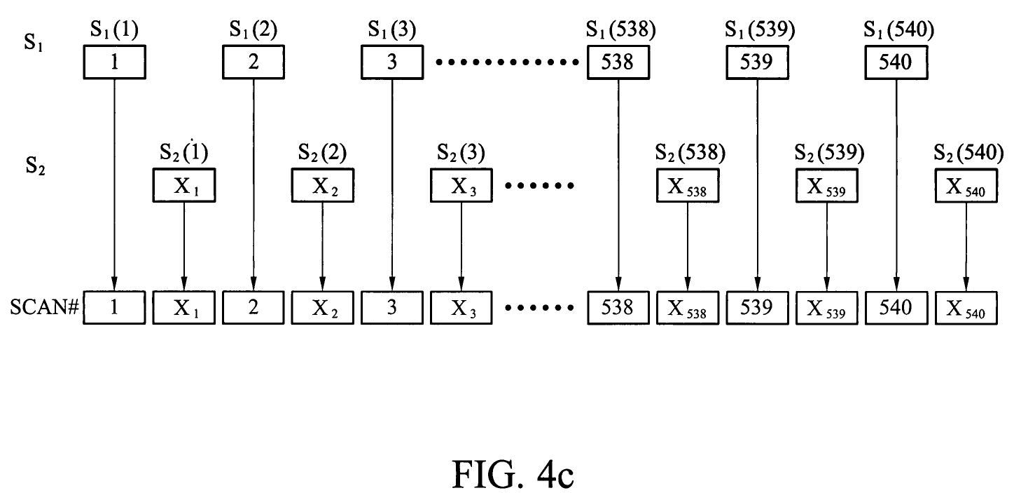

FIG. 4a shows an embodiment of the scan sequences. The liquid crystal display comprises 1080 lines, divided into two parts each comprising 540 lines. The sequence S₁ comprises 540 elements, {1, 2, 3, . . . , 540}. The sequence S₂ comprises 540 elements, {(N+1)% 540, (N+2)% 540, (N+3)% 540 . . . , (N+540)% 540}, where N is an integer no less than 540, and “%” denotes the congruent operation in order to limit the value between 0 to 540. In the embodiment, N=536, thus S₂ is shown as {537, 538, 539, 540, 1, 2, . . . , 536}. Through interlacing the sequences S₁ and S₂, a scan order SCAN# is obtained, shown as {1, 537, 2, 538, 3, 539, 4, 540, 5, 1, 6, 2, . . . , 540, 536}, comprising a total of 1080 elements. The upper part 106 and lower part 108 thus scan the corresponding lines based on the scan order SCAN#.

In another embodiment, N=270, S₂={271, 272, 273, . . . , 510, 1, . . . , 270}. The scan order SCAN# thus becomes {1, 271, 2, 272, 3, 273, 4, 274, 5, 275, . . . , 540, 270}. Further in another embodiment, N=135, S₂={136, 137, 138, . . . , 540, 1, . . . , 135}. The scan order SCAN# is then shown as {1, 136, 2, 137, 3, 138, 4, 139, 5, 140, . . . , 540, 135}. The upper part 106 and lower part 108 thus scan the corresponding lines based on the scan order SCAN#.

FIG. 4b is a timing chart according to FIG. 4a. The scan order SCAN# determines the activating order of the lines in the upper part 106 and lower part 108. For example, when DE=1, the upper part 106 activates signal G1, and the lower part 108 activates the signal G541. When DE=2, the upper part 106 activates signal G537, and the lower part 108 activates the signal G1077. The 1080 lines are not limited to being divided into two groups, and can also be divided into four groups or eight groups. If the 1080 lines are divided into four groups each comprising 270 lines, four sequences S₁ to S₄ are required to calculate the scan order. In this case, the sequences S₁ and S₂ may be derived through the described method, and the sequences S₃ and S₄ can be determined based on the accumulated power consumption of the lines. For each line, four scans are provided, the display can be enhanced by adjusting the scan order. Specifically, an equation can be provided to describe the sequences.
S₁(x)=(x+Nᵢ) (mod M), i=1 to K, x=1 to M

where Sᵢ(x) denotes the xₜₕ element in sequence Sᵢ, and (mod M) denotes a congruence residue operation that ensures the Si (x) to be a positive integer not exceeding M. The shift values N₂ to N_{K} may form a non-decreasing function ranging from 1 to M.

FIG. 4c shows another embodiment of the scan sequences. Two sequences are provided, in which S₁={1, 2, 3, . . . , 540}, and S₂ is defined to be {X₁, X₂, X₃, . . . X₅₃₈, X₅₃₉, X₅₄₀}, where X₁ to X₅₄₀ can be obtained from a hash function or dependant on characteristics of the image. Any algorithm related to the image can be used to generate the sequence S₂, thus the scan order can be flexibly adjusted.

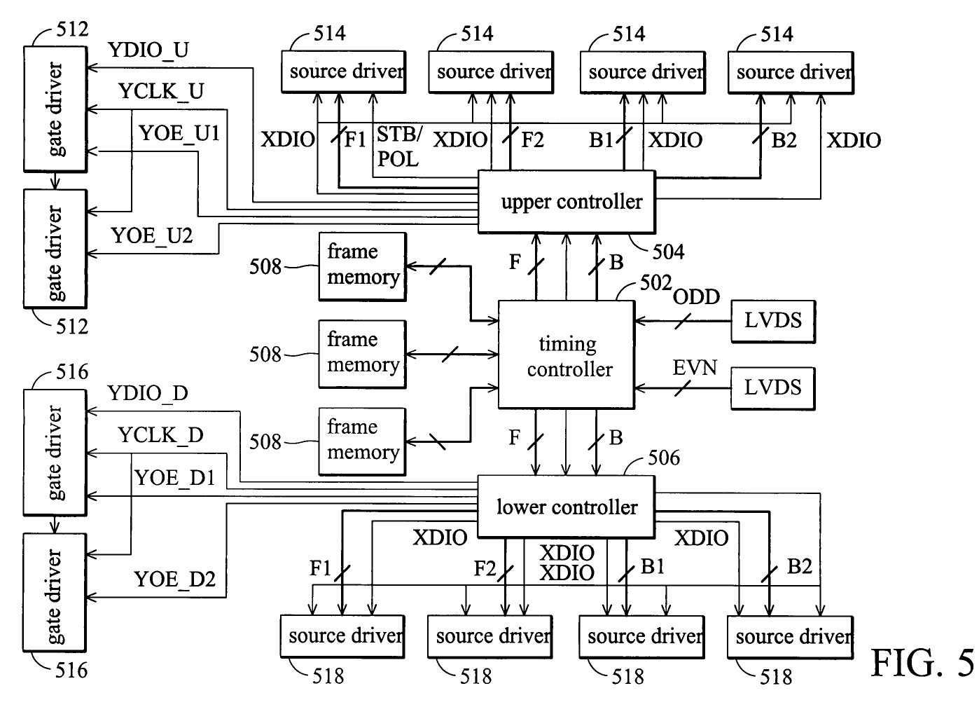

FIG. 5 shows an embodiment of a pixel driving circuit 500 the pixel driving circuit 500 is divided into upper part 106 and lower part 108, and comprises a timing controller 502 coupled to a upper controller 504 and lower controller 506. The upper controller 504 controls gate drivers 512 and source drivers 514, and the lower controller 506 controls gate drivers 516 and source drivers 518. The pixel driving circuit 500 also comprises a frame memory 508 coupled to the timing controller 502, functioning as a buffer for the timing controller 502 to process images. The timing controller 502 is capable of generating the scan order and driving the upper part 106 and lower part 108 via control of gate drivers 512 and gate drivers 516. Simultaneously, the image data are delivered to source drivers 514 and source drivers 518. In the pixel driving circuit 500, the timing controller 502 cooperates with the frame memory 508 to generate the scan order based on the described method, enhancing display quality and response time.

While the invention has been described by way of example and it terms of the preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A scan method for a flat panel display comprising K groups of lines, comprising:
providing K sequences S₁ to S_{K};
determining a scan order according to the K sequences S₁ to S_{K}; and
synchronously scanning the K groups of lines based on the scan order; wherein K is an integer not less than 2.

2. The scan method as claimed in claim 1, wherein:
each group of lines comprises at least M lines;
the step of providing K sequences S₁ to S_{K} comprises:
providing K shift values N₁ to N_{K}, wherein the shift values are not greater than M;
determining the sequences S₁ to S_{K} based on the shift values N₁ to N_{K}; and
the step of determining the scan order comprises sequentially selecting all the first elements in the sequences S₁ to S_{K}, all the second elements in the sequences S₁ to S_{K}, and so on until the Mₜₕ elements of the sequences S₁ to S_{K}, to form the scan order comprising K*M elements.

3. The scan method as claimed in claim 2, wherein the step of providing K shift values comprises determining the shift values according to characteristics of images displayed.

4. The scan method as claimed in claim 2, wherein:
Sᵢ(x)=(x+Nᵢ) (mod M), i=1 to K, x=1 to M;
Where Sᵢ(x) denotes the xₜₕ element in sequence Sᵢ.

5. The scan method as claimed in claim 4, wherein the shift value N₁ is zero.

6. The scan method as claimed in claim 5, wherein:
the shift values N₂ to N_{K} form a non-decreasing function ranging from 1 to M.

7. A timing controller, for a liquid crystal display comprising a plurality of lines, wherein:
the timing controller divides the lines into K groups;
the timing controller provides K sequences S₁ to S_{K} to determine a scan order;
the timing controller synchronously scans the K groups of lines based on the scan order; and
K is an integer not less than 2.

8. The timing controller as claimed in claim 7, wherein:
each group of lines comprises at least M lines;
the timing controller provides K shift values N₁ to N_{K}, wherein the shift values are not greater than M;
the timing controller determines the sequences S₁ to S_{K} based on the shift values N₁ to N_{K}; and
the timing controller sequentially selects all the first elements in the sequences S₁ to S_{K}, all the second elements in the sequences S₁ to S_{K}, and so on until the Mₜₕ elements of the sequences S₁ to S_{K}, to form the scan order comprising K*M elements.

9. The timing controller as claimed in claim 8, wherein the timing controller determines the shift values according to characteristics of images displayed

10. The timing controller as claimed in claim 8, wherein:
Sᵢ(x)=(x+Nᵢ) (mod M), i=1 to K, x=1 to M;
where Sᵢ(x) denotes the xₜₕ element in sequence Sᵢ; and
(mod M) denotes a congruence residue operation that ensures the Si (x) to be a positive integer not exceeding M.

11. The timing controller as claimed in claim 8, wherein the shift value N1 is zero.

12. The timing controller as claimed in claim 11, wherein:
the shift values N₂ to N_{K} formula non-decreasing function ranging from 1 to M.

13. A pixel driving circuit for a flat panel display, synchronously scanning K groups of lines in one time frame, comprising:
K gate drivers, each driving a corresponding group of lines;
a timing controller, coupled to the K gate drivers, for controlling a processing order and image data;
a frame memory, coupled to the timing controller, for storing the image data; wherein
the timing controller provides K sequences S₁ to S_{K} to determine a scan order;
the timing controller synchronously scans the K groups of lines based on the scan order via the K gate drivers; and
K is an integer not less than 2.

14. The pixel driving circuit as claimed in claim 13, wherein:
each group of lines comprises at least M lines;
the timing controller provides K shift values N₁ to N_{K}, wherein the shift values are not greater than M;
the timing controller determines the sequences S₁ to S_{K} based on the shift values N₁ to N_{K}; and
the timing controller sequentially selects all the first elements in the sequences S₁ to S_{K}, all the second elements in the sequences S₁ to S_{K}, and so on until the Mₜₕ elements of the sequences S₁ to S_{K}, to form the scan order comprising K*M elements.

15. The pixel driving circuit as claimed in claim 14, wherein the timing controller determines the shift values according to characteristics of images displayed

16. The pixel driving circuit as claimed in claim 14, wherein:
Sᵢ(x)=(x+Nᵢ) (mod M), i=1 to K, x=1 to M;
where Sᵢ(x) denotes the xₜₕ element in sequence Sᵢ; and
(mod M) denotes a congruence residue operation that ensures the Si (x) to be a positive integer not exceeding M.

17. The pixel driving circuit as claimed in claim 16, wherein the shift value N1 is zero.

18. The pixel driving circuit as claimed in-claim 16, wherein:
the shift values N₂ to N_{K} form a non-decreasing function ranging from 1 to M.
